(19) United States
(12) Patent Application Publication
(10) Pub. No.: US 2010/0110491 A1
(43) Pub. Date: May 6, 2010

(54) PRINTER, CONTROL METHOD THEREFOR, AND STORAGE MEDIUM STORING CONTROL PROGRAM THEREFOR

(75) Inventor: Yoko Murase, Yokohama-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/611,414

(22) Filed: Nov. 3, 2009

(30) Foreign Application Priority Data
Nov. 4, 2008 (JP) 2008-283305

(51) Int. Cl. G06F 3/12

(52) U.S. Cl. 358/1.15

(57) ABSTRACT

A printer that enables to grasp a printer name on an information processing apparatus by a user easily when a printer driver is installed to the information processing apparatus from the printer side. A connection unit connects a portable information storage medium that equips an information processing module provided with an information acquisition unit that acquires and saves device information of the information processing apparatus, and a name saving unit that saves printer name information. An acquisition unit acquires the device information and the printer name information from the portable information storage medium. A registration unit accesses the information processing apparatus based on the device information acquired by said acquisition unit, and to register the printer into the information processing apparatus. A setting unit sets up the printer name acquired by said acquisition unit as a printer name of the printer registered into the information processing apparatus.

### BACKGROUND OF THE INVENTION

1. Field of the Invention

The present invention relates to a printer that is connected to an information processing apparatus via a network, a control method therefor, and a storage medium storing a control program therefor.

2. Description of the Related Art

Conventionally, when installing a printer driver to an information processing apparatus such as a personal computer (referred to as only a PC hereafter), a user has to check a model of a printer, search a printer driver corresponding to the checked model, download the printer driver, and install it. Further, since the user has to set an IP address, such operations are difficult and troublesome for the user who is poor in knowledge of devices and networks.

In view of this problem, Japanese laid-open patent publication (Kokai) No. 2007-80156 (JP2007-80156A) discloses a technique in which a printer that a user is going to use installs a printer driver to a user's PC. The technique disclosed in the publication saves a password, an IP address of the user's PC and the like into a user's ID card beforehand. When the user logs in the printer using the ID card and accesses the user's PC from the printer to operate the PC remotely, the printer driver is installed into the PC from the printer side.

However, if the printer driver is installed into the PC from the printer side, a model name of the printer is automatically set as an identification name (referred to as a printer name hereinafter) of the printer on the PC in general. Otherwise, an arbitrary printer name generated at random is set up. Therefore, there is a problem in that it is difficult for the user to specify the printer that the user actually wants to use by the printer name displayed on the PC when the user returns to an installed site of the user's PC from the location of the printer in order to print actually. Particularly, this problem becomes more significant when the printer drivers of a plurality of printers of the same model are installed by this method.

### SUMMARY OF THE INVENTION

The present invention provides a printer, a control method therefor, and a storage medium storing a control program therefor, which are capable of grasping a printer name on an information processing apparatus by a user easily when a printer driver is installed to the information processing apparatus from the printer side.

Accordingly, a first aspect of the present invention provides a printer connected to an information processing apparatus via a network, comprising a connection unit adapted to connect a portable information storage medium that equips an information processing module provided with an information acquisition unit that acquires and saves device information of the information processing apparatus, and a name saving unit that saves printer name information for a user to identify a printer in the information processing apparatus, an acquisition unit adapted to acquire the device information and the printer name information from the portable information storage medium, a registration unit adapted to access the information processing apparatus based on the device information acquired by the acquisition unit, and to register the printer into the information processing apparatus, and a setting unit adapted to set up the printer name acquired by the acquisition unit as a printer name of the printer registered into the information processing apparatus.

Accordingly, a second aspect of the present invention provides a printer connected to an information processing apparatus via a network, comprising a connection unit adapted to connect a portable information storage medium that equips an information processing module provided with an information acquisition unit that acquires and saves device information of the information processing apparatus, an acquisition unit adapted to acquire the device information from the portable information storage medium, an input unit adapted to make a user input a printer name, a registration unit adapted to access the information processing apparatus based on the device information acquired by the acquisition unit, and to register the printer into the information processing apparatus, and a setting unit adapted to set up the printer name inputted by the input unit as a printer name of the printer registered into the information processing apparatus.

Accordingly, a third aspect of the present invention provides a printer connected to an information processing apparatus via a network, comprising a connection unit adapted to connect a portable information storage medium that equips an information processing module provided with an information acquisition unit that acquires and saves device information of the information processing apparatus, and a name saving unit that saves printer name information for a user to identify a printer in the information processing apparatus, a driver saving unit adapted to save a corresponding printer driver, an acquisition unit adapted to acquire the device information and the printer name information from the portable information storage medium, an installation unit adapted to access the information processing apparatus based on the device information acquired by the acquisition unit, and to install the printer driver into the information processing apparatus, a setting unit adapted to set up the printer name acquired by the acquisition unit as a printer name of the printer driver installed into the information processing apparatus, and an instruction unit adapted to instruct a test print by the printer driver that is installed into the information processing apparatus and whose printer name has been set up by the setting unit.

Accordingly, a fourth aspect of the present invention provides a printer connected to an information processing apparatus via a network, comprising a connection unit adapted to connect a portable information storage medium that equips an information processing module provided with an information acquisition unit that acquires and saves device information of the information processing apparatus, a driver saving unit adapted to save a corresponding printer driver, an acquisition unit adapted to acquire the device information from the portable information storage medium, a generation unit adapted to generate a printer name automatically, an installation unit adapted to access the information processing apparatus based on the device information acquired by the acquisition unit, and to install the printer driver into the information processing apparatus, a setting unit adapted to set up the printer name automatically generated by the generation unit as a printer name of the printer driver installed into the information processing apparatus, and an instruction unit adapted to instruct a test print by the printer driver that is installed into the information processing apparatus and to which the generated printer name has been set up.

According to the present invention, the user can grasp the printer name on the information processing apparatus easily when the printer driver is installed to the information processing apparatus from the printer side. As a result, particularly, for example, when the printer drivers of a plurality of printers are installed to the information processing apparatus from the printer side at a time, the user can easily specify the printer that the user wants to use when printing from the information processing apparatus actually, which improves a convenience of the user.

Further features of the present invention will become apparent from the following description of exemplary embodiments with reference to the attached drawings.

### BRIEF DESCRIPTION OF THE DRAWINGS

FIG. 1 is a configuration diagram schematically showing an entire system according to an embodiment of the present invention.

FIG. 2 is a block diagram showing one configuration example of a client PC shown in FIG. 1.

FIG. 3 is a block diagram showing an outline configuration of a printer shown in FIG. 1.

FIG. 4 is a schematic diagram showing a printer driver installation support module.

FIG. 5 is a flowchart showing a PC information acquisition process according to the embodiment.

FIG. 6A, FIG. 6B, and FIG. 6C are views showing screens displayed by the printer driver installation support module.

FIG. 7A, FIG. 7B, and FIG. 7C are views showing screens displayed by the printer driver installation support module.

FIG. 8 is a flowchart showing a printer driver installation process according to the embodiment.

FIG. 9 is a view showing an install destination PC confirmation screen.

FIG. 10 is a flowchart showing a printer name determination process according to the embodiment.

FIG. 11A and FIG. 11B are views showing screens displayed by the printer driver installation support module.

FIG. 12A and FIG. 12B are views showing screens displayed by the printer driver installation support module.

### DESCRIPTION OF THE EMBODIMENTS

Hereafter, an embodiment according to the present invention will be described in detail with reference to the drawings.

(A) Configuration of Entire System

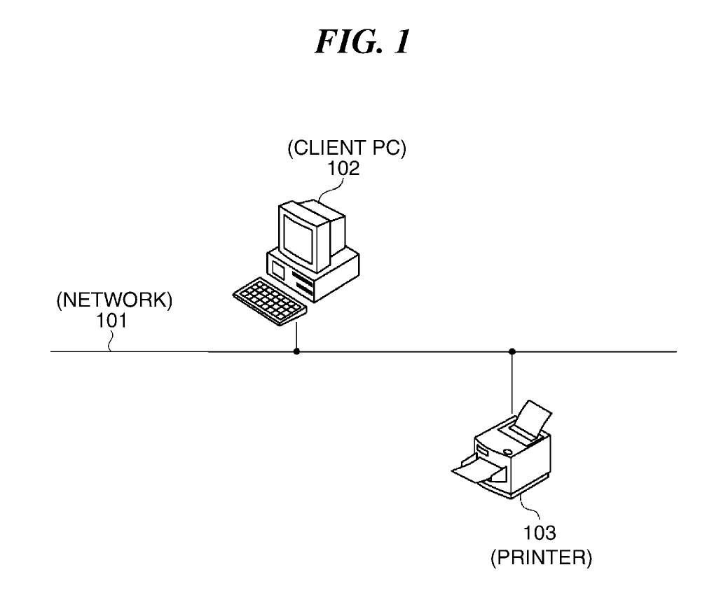

FIG. 1 is a configuration diagram schematically showing an entire system according to the embodiment of the present invention.

As shown in FIG. 1, in this network system, a client PC 102 and a network printer (referred to as a printer hereinafter) 103 are connected with each other via a network 101. The network 101 uses a known technique to connect a plurality of devices, for example, the Ethernet (registered trademark) using a TCP/IP protocol etc. is used. The client PC 102 transmits a print request to the printer 103, and the printer 103 prints in response to the print request. In FIG. 1, although one client PC and one printer are connected, respectively, a plurality of client PCs and a plurality of printers may be connected.

(B) Configuration of Client PC

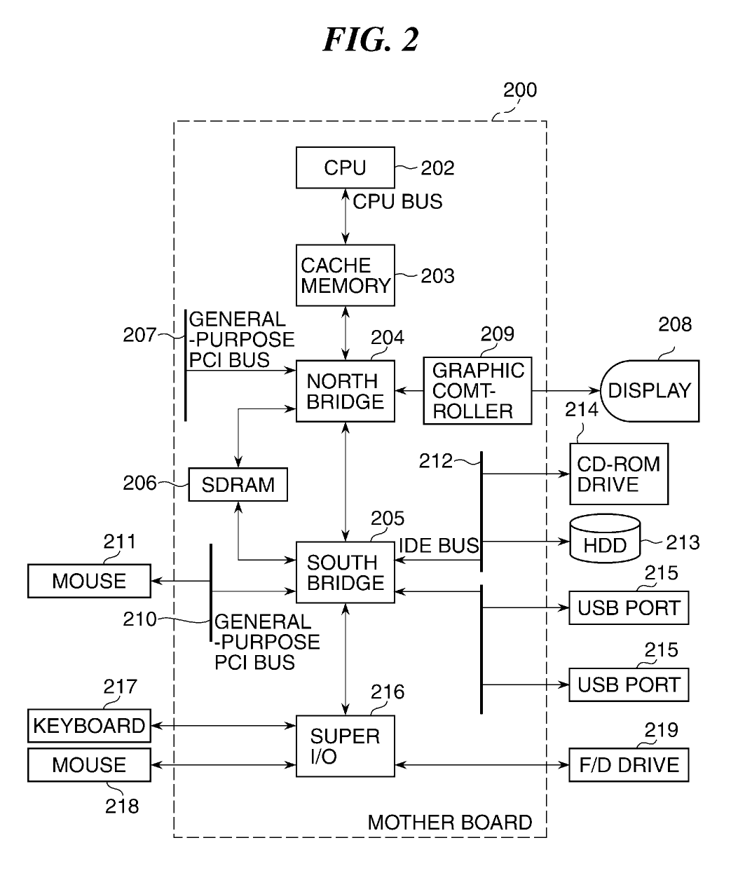

FIG. 2 is a block diagram showing one configuration example of the client PC 102 shown in FIG. 1.

As shown in FIG. 2, the client PC 102 is provided with a mother board 200 on which a CPU 202, a cache memory 203, a north bridge 204, a south bridge 205, an SDRAM 206, a graphic controller 209, etc. are placed.

The CPU 202 is controlling the entire software of the client PC 102, while communicating with the north bridge 204 and the south bridge 205 via the cache memory 203. Here, the memory (the SDRAM 206) is used for an exchange of data between the north bridge 204 and the south bridge 205, sand for a temporal saving of data in the client PC 102.

The north bridge 204 has a general-purpose PCI bus (32 bits/33 MHz) 207 to which a SCSI external device etc. can be connected as an option (retrofitting). The north bridge 204 is also connected to the graphic controller 209 for displaying a display 208. The south bridge 205 has another general-purpose PCI bus 210 to which the network 101 is connected via an NIC 211.

The south bridge 205 also has an IDE bus 212, and a hard disk drive (HDD) 213 that stores control software of the client PC 102 and various data is connected thereto. A CD-ROM (or CD-R, CD-R/W) drive 214 that is useful for the data read at the time of installation of the client PC 102 and for the data storage (archive) of mass data, etc. is connected through the IDE bus 212.

A USB external device represented by a USB memory is connected to a USB port 215. And the south bridge 205 is connected to a keyboard 217, a mouse 218 or a floppy (registered trademark) disk drive (F/D drive) 219 via a super I/O unit 216 for outputting and inputting data.

(C) Outline Configuration of Printer

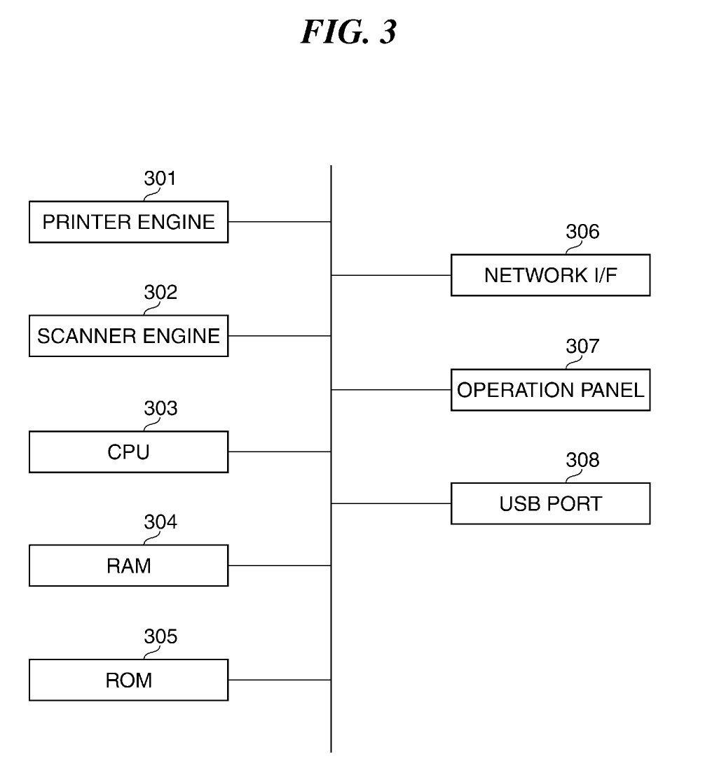

FIG. 3 is a block diagram showing an outline configuration of the printer 103 shown in FIG. 1. In this example, the printer 103 serves as a multifunctional peripheral device.

In FIG. 3, the printer 103 is provided with a printer engine 301, a scanner engine 302, a central processing unit (referred to as a “CPU” hereinafter) 303, a RAM 304, a ROM 305, a network interface (I/F) 306, an operation panel 307, and a USB port 308.

The printer engine 301 uses a known printing technique, such as an electro photography method or an inkjet method. The scanner engine 302 uses a known optical reading technique. The CPU 303 controls the entire operation of the printer 103. The ROM 305 stores an operation control program executed by the CPU 303. The network I/F 306 is an interface for connecting to the network 101. The operation panel 307 comprises a display device such as a liquid crystal panel and a LED, and a plurality of operation buttons, for example, and provides a user interface. The RAM 304 temporarily stores image data that is printed by the printer engine 301. A USB external device represented by a USB memory is connected to the USB port 308.

(D) Printer Driver Installation Support Module in Information Storage Medium

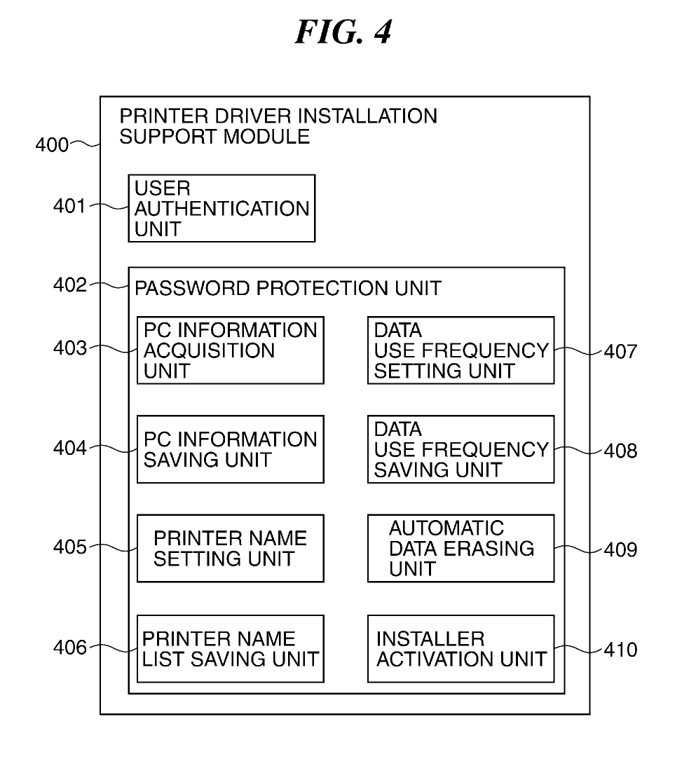

FIG. 4 is a schematic view showing a printer driver installation support module (an information processing module) stored in an information storage medium such as a USB memory that can be carried by a user.

The printer driver installation support module 400 is started and executed, when the information storage medium that is a storage unit thereof is connected to a device such as the client PC 102 or the printer 103. The printer driver installation support module 400 includes a user authentication unit 401 and a password protection unit 402, as shown in FIG. 4.

When the information storage medium is connected to the device and the installation support module 400 is automatically started or is manually started by the user, the user authentication unit 401 performs authentication before the user uses a function. When a password is not set up, the user authentication unit 401 instructs the user to set up a password.

The password protection unit 402 organizes a plurality of function groups, and the password protection unit 402 allows to access to each function therein when an authentication is performed by the user authentication unit 401. The password protection unit 402 is provided with the following functions as shown in FIG. 4. Namely, the password protection unit 402 is provided with a PC information acquisition unit 403, a PC information saving unit 404, a printer name setting unit 405, a printer name list saving unit 406, a data use frequency setting unit 407, and a data use frequency saving unit 408, an automatic data erasing unit 409, and an installer activation unit 410.

The PC information acquisition unit 403 acquires device information of the client PC 102 such as a computer name, an OS, and an IP address, when the installation support module 400 is connected to the client PC 102. The PC information saving unit 404 saves the device information of the PC that is acquired by the PC information acquisition unit 403. The printer name setting unit 405 instructs a user to set up a printer name, when the installation support module 400 is connected to the client PC 102. The printer name setting unit 405 executes a printer name determination process (described below), when the installation support module 400 is connected to the printer 103.

The printer name list saving unit 406 saves the printer name list that is set by the user using the printer name setting unit 405. When the printer name cannot be set up from the printer side because an operation unit of the printer does not have a display panel due to its poor configuration, the printer name can be set from the client PC 102 side using the printer name list saved in the printer name list saving unit 406.

The data use frequency setting unit 407 instructs the user to set up the data use frequency that is set in the PC information saving unit 404 and the printer name list saving unit 406. The data use frequency saving unit 408 saves the data use frequency set up by the data use frequency setting unit 407. The automatic data erasing unit 409 counts a data use frequency, and erases the data in the PC information saving unit 404 and the printer name list saving unit 406 when the count reaches the data use frequency saved in the data use frequency saving unit 408. The installer activation unit 410 starts an installer of the printer driver saved in the ROM 305 etc. of the printer 103.

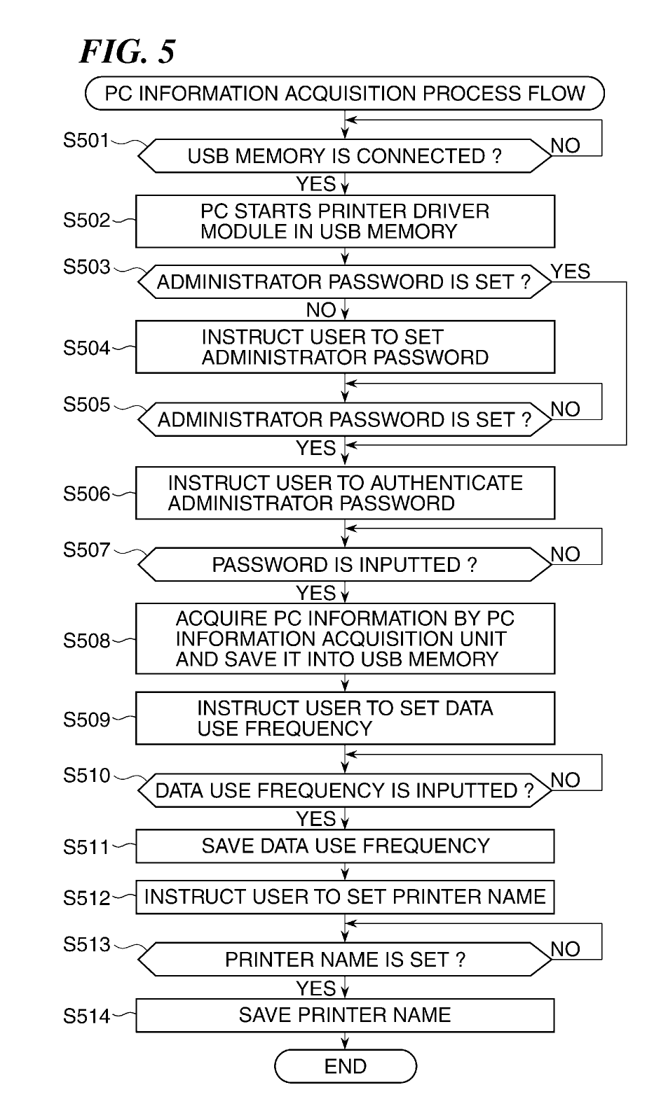

A flow in which the PC information is acquired and saved into the information storage medium will be described with reference to FIGS. 5, 6A, 6B, 6C, 7A, 7B, and 7C. In the following description, a USB memory is used as the information storage medium, for example.

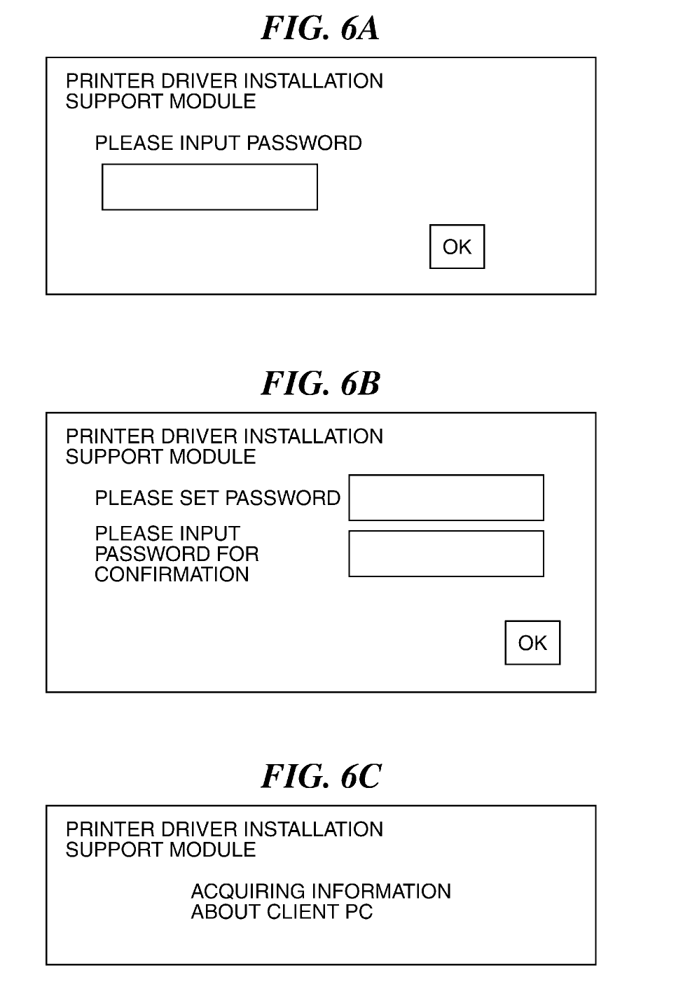

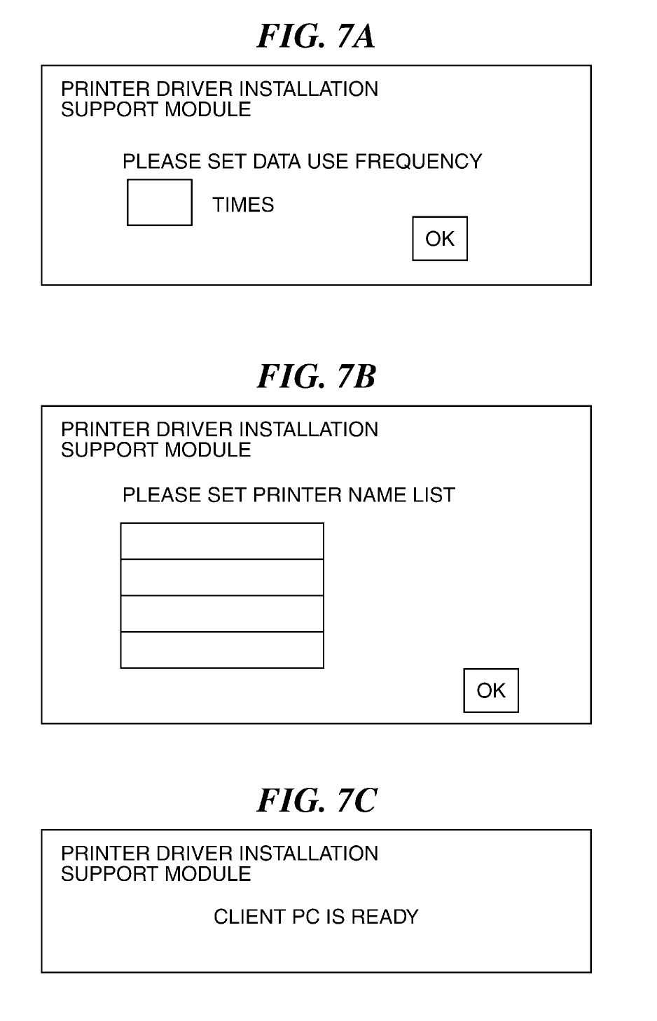

FIG. 5 is a flowchart showing a PC information acquisition process according to this embodiment. FIGS. 6A, 6B, 6C, 7A, 7B, and 7C are views showing screens displayed by the printer driver installation support module according to this embodiment.

First, a user connects a USB memory in which the installation support module 400 is stored to the USB port 215 etc. of the client PC 102 of the user. The CPU 202 of the client PC 102 checks connection of the USB memory in step S501.

In the next step S502, the CPU 202 of the client PC 102 starts the installation support module 400 stored in the USB memory. In the following step S503, the CPU 202 checks whether an administrator password has been set in the user authentication unit 401. When the administrator password has been already set, the CPU 202 displays a password input screen of FIG. 6A on the display 208, and instructs a password authentication in step S506.

When the administrator password has not been set, the CPU 202 displays a password setting screen of FIG. 6B on the display 208, and instructs the user to set an administrator password in step S504. In response to it, the user sets up the administrator password. In step S503, the CPU 202 checks whether the user has set the administrator password. When the user has set the administrator password, the CPU 202 displays the password input screen of FIG. 6A on the display 208, and instructs the administrator password authentication in step S506. If the user inputs the administrator password in response (step S507), the CPU 202 proceeds with the process to step S508 via the password authentication.

In step S508, the CPU 202 displays the screen for acquiring the PC information shown in FIG. 6C on the display 208, controls the PC information acquisition unit 403 to acquire the PC information such as an OS name and an IP address from the client PC 102, and saves it into the PC information saving unit 404. After acquiring the PC information using the PC information acquisition unit 403, the CPU 202 displays a data use frequency setting screen of FIG. 7A on the display 208, and instructs the user to set a use frequency of the PC information data acquired now in step S509.

Confirming the setup of the data use frequency by the user in step S510, the CPU 202 saves the set-up data use frequency into the data use frequency saving unit 408 in the next step S511. Then, the CPU 202 displays a printer name list setting screen of FIG. 7B on the display 208 by the printer name setting unit 405, and instructs the user to set a printer name in step S512.

Then, confirming the setup of the printer name by the user (step S513), the CPU 202 saves the printer name set by the user into the printer name list saving unit 406. It should be noted that the user does not need to set up the printer name if unnecessary.

Up to here the PC information acquisition flow is finished and a PC information acquisition completion screen of FIG. 7C is displayed on the display 208.

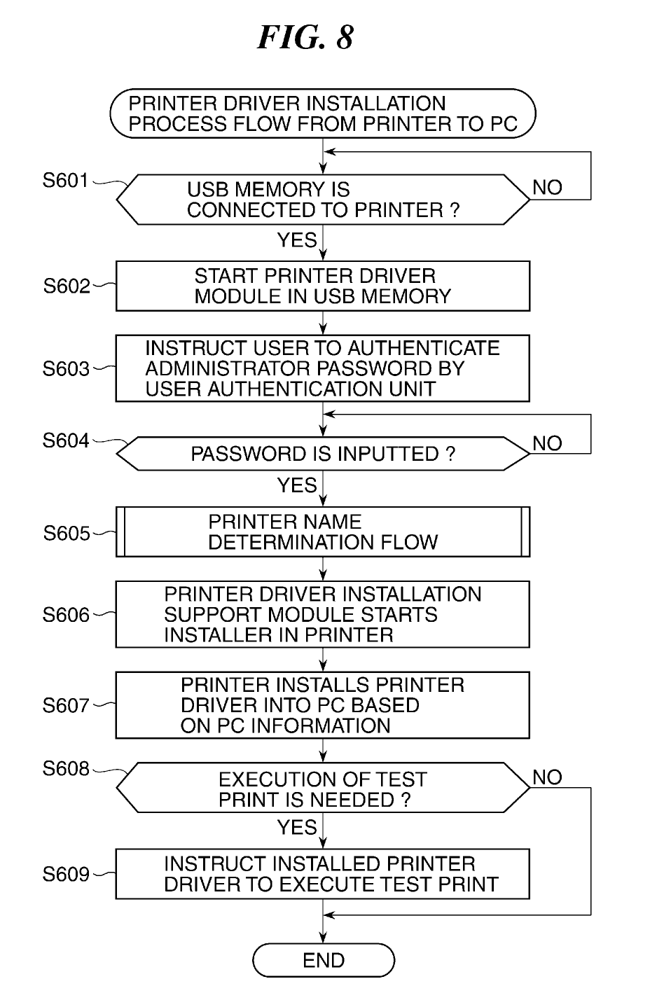

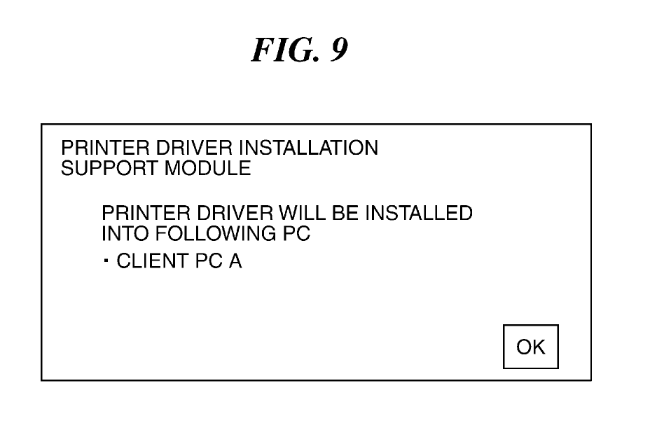

Next, a printer driver installation process flow to install the printer driver from the printer to the PC will be described with reference to FIG. 8 and FIG. 9. FIG. 8 is a flowchart showing the printer driver installation process according to this embodiment.

First, the user connects the USB memory, which acquired and saved the PC information in the above-mentioned PC information acquisition flow executed by the installation support module 400, to the USB port 308 of the printer 103.

Confirming the connection of the USE memory in step S601, the CPU 303 of the printer 103 automatically starts the installation support module 400 in the USB memory in the next step S602. Otherwise the user may start the installation support module 400 manually from the operation panel 307.

Next, in step S603, the CPU 303 controls the user authentication unit 401 to display the password input screen of FIG. 6A on the operation panel 307 of the printer 103, and instructs the user to authenticate the password. In response to it, the user sets up the password on the operation panel 307.

Confirming that the password has been set up (step S604), the CPU 303 determines a printer name for identifying the printer 103 on the client PC 102 in step S605. Details of the printer name determination flow in step S605 will be described later.

Next, the CPU 303 controls the installer activation unit 410 to start an installer of the printer driver stored in the ROM 305 of the printer 103 in step S606. When the printer 103 does not include the installer of the printer driver or only includes an installer that does not correspond to the OS of the client PC 102, an appropriate installer can be searched and acquired from the network.

Then, the CPU 303 displays an install destination PC confirmation screen shown in FIG. 9 on the operation panel 307, and makes a user confirm the client PC 102 into which the printer driver is installed in step S607. And if the user depresses an OK button to allow installation, the printer driver is installed into the client PC 102 by the installer inside the printer 103 based on the IP address saved in the PC information saving unit 404.

That is, the CPU 303 acquires the IP address as the device information from the PC information saving unit 404 of the USB memory, accesses to the client PC 102 via the network based on the IP address, and installs the printer driver to the client PC 102. At the time of the installation, the printer name determined by the printer name determination flow in step S605 is sent to the client PC 102, and it is set as a printer name of the printer driver that is installed to the client PC 102 concerned.

After finishing the installation, the CPU 303 determines whether a test print is executed in step S608 based on a test print execution flag that is set when the printer name is determined in step S605. When not executing a test print, the process is finished as is. When executing a test print, the CPU 303 controls the printer driver that has been installed from the printer 103 into the client PC 102 to execute the test print in step S609.

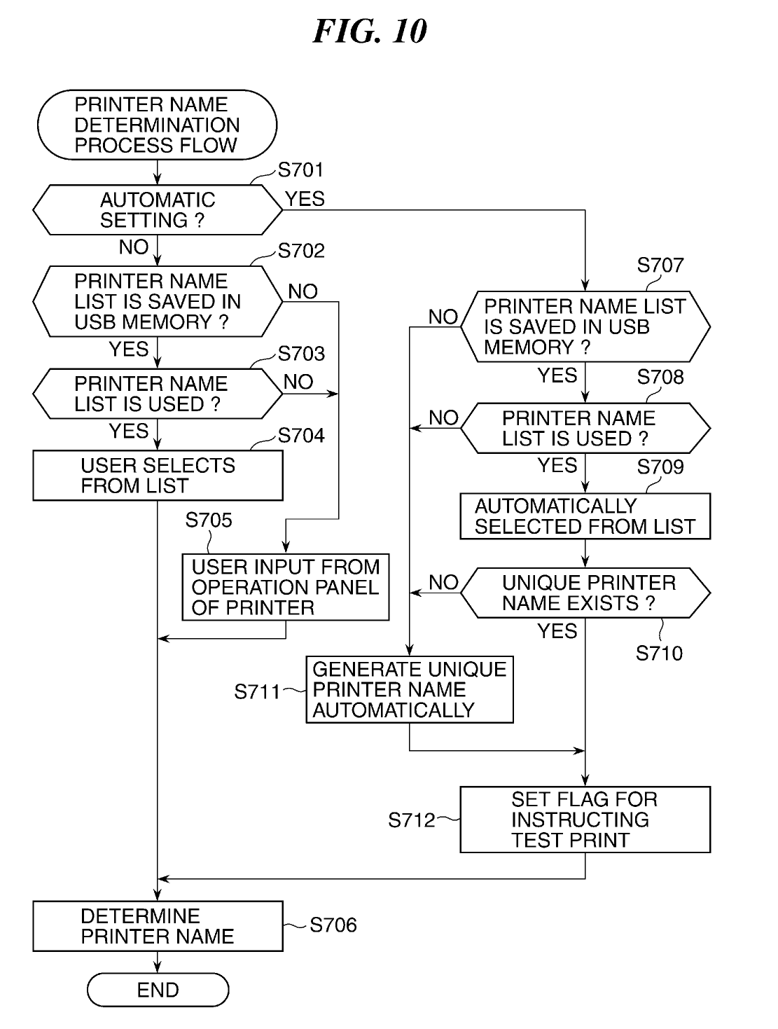

Next, the printer name determination flow that the CPU 303 of the printer 103 performs in step S606 of FIG. 8 will be described with reference to FIGS. 10, 11A, 11B, 12A, and 12B. FIG. 10 is a flowchart showing the printer name determination process according to this embodiment.

(A) Case of User's Manual Setting of Printer Name

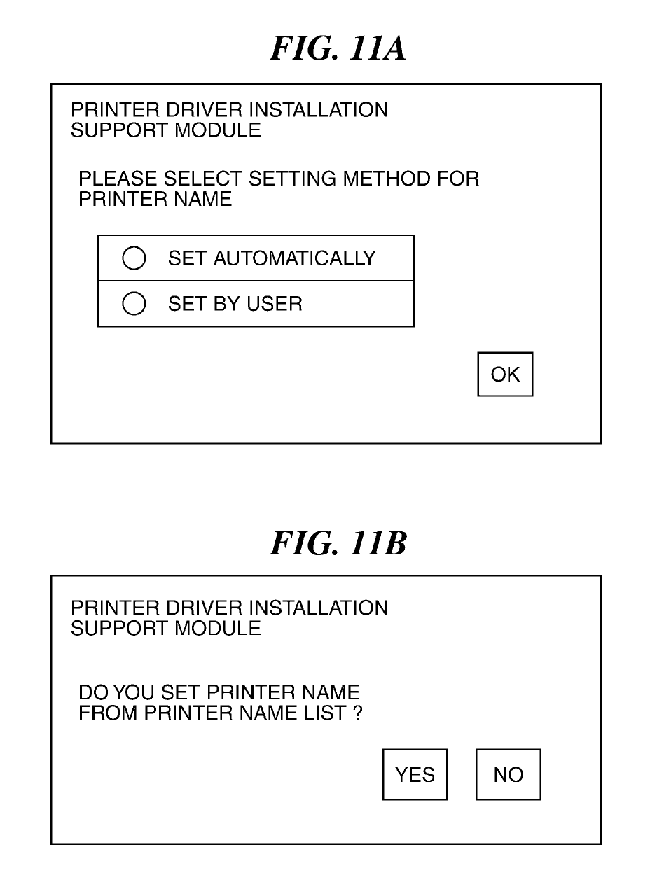

The CPU 303 of the printer 103 displays a printer name setting method selection screen shown in FIG. 11A on the operation panel 307 in step S701 of FIG. 10, and makes a user select either an automatic setting of a printer name or a user's manual setting of a printer name.

When the user selects the user's manual setting of the printer name, the CPU 303 checks whether the printer name list is saved in the printer name list saving unit 406 in step S702. It should be noted that the printer name list is an example of the printer name information. When the printer name list is saved, the CPU 303 displays a printer name setting method selection screen shown in FIG. 11B on the operation panel 307 in step S703, and makes the user select whether the printer name in the printer name list is used or not.

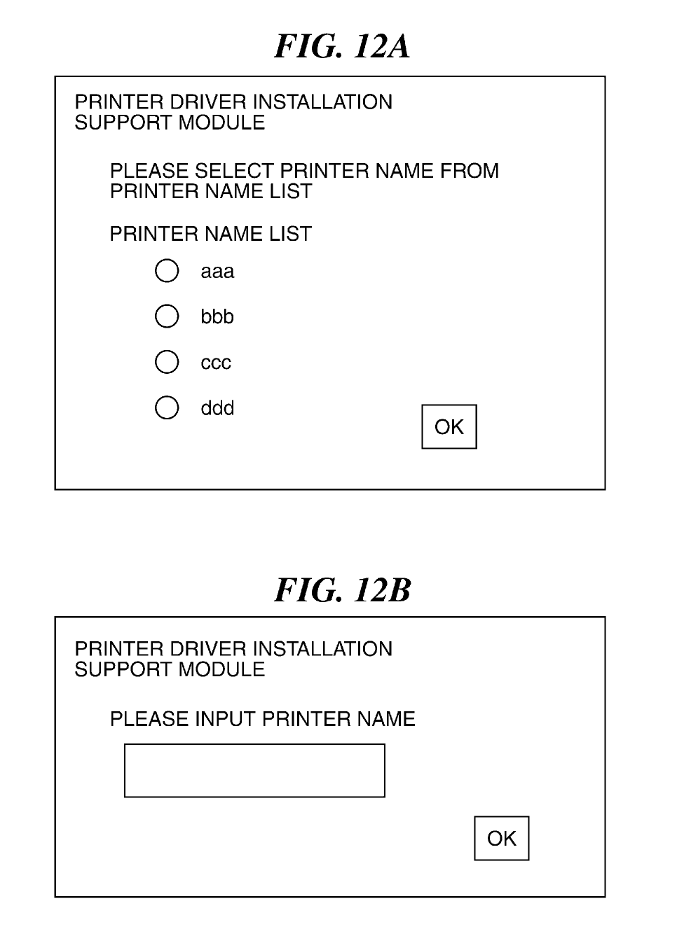

When the user determined that the printer name is set from the printer name list, the CPU 303 displays a printer name selection screen shown in FIG. 12A on the operation panel 307, and makes the user select a predetermined printer name to be used from the printer name list in step S704. After selection, the CPU 303 refers to the printer names that have been already set in the client PC 102. If the selected printer name is used in the client PC 102, the CPU 303 notifies the user of this matter by displaying etc., and makes the user repeat the selection of the printer name using the screen of FIG. 12A. If the printer name that is unique on the client PC 102 is selected, the printer name is determined in step S706.

On the other hand, when the printer name list is not saved in the printer name list saving unit 406 (NO in step S702), or when the user selects not to set up the printer name from the printer name list (NO in step S703), the process proceeds to step S705. The CPU 303 displays a printer name input screen shown in FIG. 12B on the operation panel 307, and makes the user input a printer name in step S705.

After inputting, the CPU 303 refers to the printer names that have been already set in the client PC 102. If the selected printer name is used in the client PC 102, the CPU 303 notifies the user of this matter by displaying etc., and makes the user repeat the input of the printer name using the screen of FIG. 12B. If the printer name that is unique on the client PC 102 is selected, the printer name is determined in step S706.

(B) Case of Automatic Setting of Printer Name

The CPU 303 displays the printer name setting method selection screen shown in FIG. 11A on the operation panel 307 in step S701, and makes the user select either the automatic setting of a printer name or the user's manual setting of a printer name. When the user selects the automatic setting of a printer name, the CPU 303 checks whether the printer name list is saved in the printer name list saving unit 406 in step S707.

When the printer name list is saved, the CPU 303 displays the printer name setting method selection screen shown in FIG. 11B on the operation panel 307 in step S708, and makes the user select whether the printer name in the printer name list is used or not. When the user determined that the printer name is set from the printer name list, the CPU 303 automatically selects a printer name from the printer name list in step S709.

The CPU 303 refers to the printer names that have been already selected in the client PC 102. If the selected printer name is used in the client PC 102, the CPU 303 repeats the search of the printer name list and selects a printer name.

When the printer name that can be set uniquely in the client PC 102 exists in the printer name list (YES in step S710), the flag for the test print instruction is set in step S712, and the printer name is determined in step S706.

When a printer name that is unique in the client PC 102 does not exist in the printer name list, the process proceeds to step S711. When the printer name list is not saved at the printer name list saving unit 406 (NO in step S707), the process proceeds to step S711. In the same manner, when the user selected that a printer name is not set from the printer name list in step S708, the process proceeds to step S711. In step S711, the printer name setting unit 405 automatically generates and sets up a unique printer name.

It should be noted that various methods can be considered for the process in step S711. For example, the CPU 303 sets a model name of the printer 103 as a default printer name (“LBP1000”, for example), and adds additional information to the printer name to create a new unique printer name (“LPB1000 (copy 2)”, for example) when the same printer name has been used in the client PC 102. Setting the printer name that is unique on the client PC 102, the CPU 303 sets the flag for instructing the test print in step S712, and the printer name is determined in step S706.

When a printer name is set up automatically as mentioned above, the CPU 303 sets the test print flag and performs test print after finishing the installation of the printer driver in order that the user grasps what printer name has been set. Since the printer name set on the client PC 102 is printed at the time of the test print, the user who installed the printer driver can grasp the printer name that is automatically set by seeing the content of the test print. Therefore, when the user returns to the client PC 102 and actually prints, the user can easily specify the printer based on the printer name.

On the other hand, since the user grasps the printer name when the user has manually set the printer name as mentioned above, the test print after installation of the printer driver cannot be performed, which can prevent waste printing. As a matter of course, the test print may be performed by the user's instruction.

The installation by the installation support module 400 is repeated until reaching the data use frequency saved in the data use frequency saving units 408. When reaching the saved data use frequency, the printer names saved in the PC information saving unit 404 and the printer name list saving unit 406 are erased. This can avoid an unnecessary diversion of the information stored in the portable information storage medium.

Further, when the printer name list is set up, the printer name used once in the list and the printer name already used by the client PC 102 may be deleted from the printer name list.

According to this embodiment, the USB memory as the portable information storage medium saves the device information of the user's client PC, the printer name list set by the user, and the like. Connecting the USB memory to the printer, the printer driver is installed into the client PC from the printer. At the time of installation of the printer driver, the printer name that is an identification name of the printer on the client PC is manually set by the user or is automatically set. And then, the test print is performed if needed.

Thus, when installing the printer driver from the printer side to the information processing apparatus, the printer name that is designated by the user or is automatically set is set as the identification name of the printer on the client PC. When the printer name is set automatically, the printer name can be checked by the printer side by the test print. Accordingly, the check of the installation and the check of the printer name can be performed at the printer side, which improves a user's convenience. As a result, particularly, for example, when the printer drivers of a plurality of printers are installed to the client PC from the printer side at a time, the user can easily specify the printer that the user wants to use when printing from the client PC actually.

### Other Embodiments

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-283305, filed on Nov. 4, 2008, which is hereby incorporated by reference herein in its entirety.

What is claimed is:

1. A printer connected to an information processing apparatus via a network, comprising:
a connection unit adapted to connect a portable information storage medium that equips an information processing module provided with an information acquisition unit that acquires and saves device information of the information processing apparatus, and a name saving unit that saves printer name information for a user to identify a printer in the information processing apparatus;
an acquisition unit adapted to acquire the device information and the printer name information from the portable information storage medium;
a registration unit adapted to access the information processing apparatus based on the device information acquired by said acquisition unit, and to register the printer into the information processing apparatus; and
a setting unit adapted to set up the printer name acquired by said acquisition unit as a printer name of the printer registered into the information processing apparatus.

2. A printer connected to an information processing apparatus via a network, comprising:
a connection unit adapted to connect a portable information storage medium that equips an information processing module provided with an information acquisition unit that acquires and saves device information of the information processing apparatus;
an acquisition unit adapted to acquire the device information from the portable information storage medium;
an input unit adapted to make a user input printer name;
a registration unit adapted to access the information processing apparatus based on the device information acquired by said acquisition unit, and to register the printer into the information processing apparatus; and
a setting unit adapted to set up the printer name inputted by said input unit as a printer name of the printer registered into the information processing apparatus.

3. A printer connected to an information processing apparatus via a network, comprising:
a connection unit adapted to connect a portable information storage medium that equips an information processing module provided with an information acquisition unit that acquires and saves device information of the information processing apparatus, and a name saving unit that saves printer name information for a user to identify a printer in the information processing apparatus;
a driver saving unit adapted to save a corresponding printer driver;
an acquisition unit adapted to acquire the device information and the printer name information from the portable information storage medium;
an installation unit adapted to access the information processing apparatus based on the device information acquired by said acquisition unit, and to install the printer driver into the information processing apparatus;
a setting unit adapted to set up the printer name acquired by said acquisition unit as a printer name of the printer driver installed into the information processing apparatus; and
an instruction unit adapted to instruct a test print by the printer driver that is installed into the information processing apparatus and whose printer name has been set up by said setting unit.

4. A printer connected to an information processing apparatus via a network, comprising:
a connection unit adapted to connect a portable information storage medium that equips an information processing module provided with an information acquisition unit that acquires and saves device information of the information processing apparatus;
a driver saving unit adapted to save a corresponding printer driver;
an acquisition unit adapted to acquire the device information from the portable information storage medium;
a generation unit adapted to generate a printer name automatically;
an installation unit adapted to access the information processing apparatus based on the device information acquired by said acquisition unit, and to install the printer driver into the information processing apparatus;
a setting unit adapted to set up the printer name automatically generated by said generation unit as a printer name of the printer driver installed into the information processing apparatus; and
an instruction unit adapted to instruct a test print by the printer driver that is installed into the information processing apparatus and to which the generated printer name has been set up.

5. The printer according to claim 1, wherein the portable information storage medium has a saving unit for saving a data use frequency, and further comprising an erasing unit adapted to count a use frequency of the device information or the printer name information and to erase the device information or the printer name information when the count reaches the data use frequency.

6. The printer according to claim 1, wherein the name saving unit of the portable information storage medium saves two or more pieces of the printer name information.

7. The printer according to claim 6, further comprising an erasing unit, adapted to erase the printer name set by said setting unit from the name saving unit among the two or more pieces of the printer name information saved by the name saving unit.

8. The printer according to claim 2, further comprising a repeating unit adapted to repeatedly make the user input a printer name until inputting a printer name that is not used in the information processing apparatus, when the printer name that has been already used in the information processing apparatus is inputted from said input unit.

9. The printer according to claim 4, wherein said generation unit generates a printer name that is not used in the information processing apparatus.

10. A control method for a printer that is connected to an information processing apparatus via a network and is provided with a connection unit adapted to connect a portable information storage medium that equips an information processing module provided with an information acquisition unit that acquires and saves device information of the information processing apparatus, and a name saving unit that saves printer name information for a user to identify a printer in the information processing apparatus, the control method comprising:
an acquisition step of acquiring the device information and the printer name information from the portable information storage medium;
a registration step of accessing the information processing apparatus based on the device information acquired in said acquisition step, and of registering the printer into the information processing apparatus; and
a setting step of setting up the printer name acquired in said acquisition step as a printer name of the printer registered into the information processing apparatus.

11. A control method for a printer that is connected to an information processing apparatus via a network and is provided with a connection unit adapted to connect a portable information storage medium that equips an information processing module provided with an information acquisition unit that acquires and saves device information of the information processing apparatus, the control method comprising:
an acquisition step of acquiring the device information from the portable information storage medium;
an input step of making a user input a printer name;
a registration step of accessing the information processing apparatus based on the device information acquired in said acquisition step, and of registering the printer into the information processing apparatus; and
a setting step of setting up the printer name inputted in said input step as a printer name of the printer registered into the information processing apparatus.

12. A control method for a printer that is connected to an information processing apparatus via a network and is provided with a connection unit adapted to connect a portable information storage medium that equips an information processing module provided with an information acquisition unit that acquires and saves device information of the information processing apparatus, and a name saving unit that saves printer name information for a user to identify a printer in the information processing apparatus, and a driver saving unit that saves a corresponding printer driver, the control method comprising:
an acquisition step of acquiring the device information and the printer name information from the portable information storage medium;
an installation step of accessing the information processing apparatus based on the device information acquired in said acquisition step, and of installing the printer driver into the information processing apparatus;
a setting step of setting up the printer name acquired in said acquisition step as a printer name of the printer driver installed into the information processing apparatus; and
an instruction step of instructing a test print by the printer driver that is installed into the information processing apparatus and whose printer name has been set up in said setting step.

13. A control method for a printer that is connected to an information processing apparatus via a network and is provided with a connection unit adapted to connect a portable information storage medium that equips an information processing module provided with an information acquisition unit that acquires and saves device information of the information processing apparatus, and a driver saving unit that saves a corresponding printer driver, the control method comprising:
an acquisition step of acquiring the device information from the portable information storage medium;
a generation step of generating a printer name automatically;
an installation step of accessing the information processing apparatus based on the device information acquired in said acquisition step, and of installing the printer driver into the information processing apparatus;
a setting step of setting up the printer name automatically generated in said generation step as a printer name of the printer driver installed into the information processing apparatus; and
an instruction step of instructing a test print by the printer driver that is installed into the information processing apparatus and to which the generated printer name has been set up.

14. A computer-readable storage medium storing a control program causing a computer to execute a control method for a printer that is connected to an information processing apparatus via a network and is provided with a connection unit adapted to connect a portable information storage medium that equips an information processing module provided with an information acquisition unit that acquires and saves device information of the information processing apparatus, and a name saving unit that saves printer name information for a user to identify a printer in the information processing apparatus, the control method comprising:
an acquisition step of acquiring the device information and the printer name information from the portable information storage medium;
a registration step of accessing the information processing apparatus based on the device information acquired in said acquisition step, and of registering the printer into the information processing apparatus; and
a setting step of setting up the printer name acquired in said acquisition step as a printer name of the printer registered into the information processing apparatus.

15. A computer-readable storage medium storing a control program causing a computer to execute a control method for a printer that is connected to an information processing apparatus via a network and is provided with a connection unit adapted to connect a portable information storage medium that equips an information processing module provided with an information acquisition unit that acquires and saves device information of the information processing apparatus, the control method comprising:
an acquisition step of acquiring the device information from the portable information storage medium;
an input step of making a user input a printer name;
a registration step of accessing the information processing apparatus based on the device information acquired in said acquisition step, and of registering the printer into the information processing apparatus; and
a setting step of setting up the printer name inputted in said input step as a printer name of the printer registered into the information processing apparatus.

16. A computer-readable storage medium storing a control program causing a computer to execute a control method for a printer that is connected to an information processing apparatus via a network and is provided with a connection unit adapted to connect a portable information storage medium that equips an information processing module provided with an information acquisition unit that acquires and saves device information of the information processing apparatus, and a name saving unit that saves printer name information for a user to identify a printer in the information processing apparatus, and a driver saving unit that saves a corresponding printer driver, the control method comprising:
an acquisition step of acquiring the device information and the printer name information from the portable information storage medium;
an installation step of accessing the information processing apparatus based on the device information acquired in said acquisition step, and of installing the printer driver into the information processing apparatus;
a setting step of setting up the printer name acquired in said acquisition step as a printer name of the printer driver installed into the information processing apparatus; and
an instruction step of instructing a test print by the printer driver that is installed into the information processing apparatus and whose printer name has been set up in said setting step.

17. A computer-readable storage medium storing a control program causing a computer to execute a control method for a printer that is connected to an information processing apparatus via a network and is provided with a connection unit adapted to connect a portable information storage medium that equips an information processing module provided with an information acquisition unit that acquires and saves device information of the information processing apparatus, and a driver saving unit that saves a corresponding printer driver, the control method comprising:
an acquisition step of acquiring the device information from the portable information storage medium;
a generation step of generating a printer name automatically;
an installation step of accessing the information processing apparatus based on the device information acquired in said acquisition step, and of installing the printer driver into the information processing apparatus;
a setting step of setting up the printer name automatically generated in said generation step as a printer name of the printer driver installed into the information processing apparatus; and
an instruction step of instructing a test print by the printer driver that is installed into the information processing apparatus and to which the generated printer name has been set up.
